(19) United States
(12) Patent Application Publication
(10) Pub. No.: US 2004/0245208 A1
(43) Pub. Date: Dec. 9, 2004

(54) Bottle of sprayable liquid with flexible neck

(76) Inventor: Robert A. Dennison, Naples, FL (US)

Correspondence Address: EDWARD M. LIVINGSTON, PA, 963 TRAIL TERRACE DRIVE, NAPLES, FL, 34103, US

(21) Appl. No.: 10/845,851

(22) Filed: May 14, 2004

Related U.S. Application Data
(63) Continuation-in-part of application No. 10/307,577, filed on Dec. 2, 2002.

(51) Int. Cl. B65D 90/02; B65D 90/12; B67D 3/00

(52) U.S. Cl. 215/379; 215/900; 222/136; 222/383.1; 239/582.1; 239/587.1

(57) ABSTRACT

A container (1) with a flexible neck (2) that permits the neck (2) to be moved into any position while continuing to spray liquid (12) from the container (1). The container (1) can be used with any conventional spray nozzle attachment (3) having an attachment ring (4), tubing (11), a trigger (6) and a nozzle (7).

This is a continuation of application Ser. No. 10/307,577, filed Dec. 2, 2002, now abandoned.

### BACKGROUND OF THE INVENTION

This invention relates to bottles having flexible necks, more particularly, a bottle having a flexible neck that permits the bottle to be moved by the person holding the bottle from its centerline or axis as sold vertical position to any other position and continue to spray liquid from the bottle.

There are presently on sale one gallon containers made of plastic filled with automobile engine oil having flexible necks. In addition, there are also many containers for cleaning products which have a flexible neck in order for the user to squirt hard-to-reach places, such as corners, under cabinets, etc. with the cleaning fluid. However, a major disadvantage to using these types of flexible neck containers is that they are severely limited in use as the user must maintain a body portion of the container in a substantially parallel position to the floor in order for the tubing within the container to reach the liquid. Thus, although the flexible neck of these containers may permit a user to position the spray nozzle in positions away from a perpendicular axis to the floor, the user must also maintain the bottle in a parallel position to the floor, meaning that if the liquid in the container is low, the user can no longer squirt the liquid in a hard-to-reach area as the container must now be tilted, thereby exposing the tubing within the container to air rather than the liquid. In addition, users of the conventional flexible neck containers cannot turn the containers upside down in order to spray upwards due to either the tubing no longer being in contact with liquid, spillage or both. Thus, the need exists for a container having a flexible neck that permits a user to flex the flexible neck in such a fashion to use all of the liquid within the container and/or spray upwards while still maintaining the container in a substantially parallel position relative to the floor to allow the tubing within the container to maintain contact with the liquid.

### SUMMARY OF THE INVENTION

The primary object of the present invention is to provide a bottle of sprayable liquid with flexible neck that permits a user to flex the neck in any direction.

Another object of the present invention is to provide a bottle of sprayable liquid with flexible neck that permits a user to flex the neck in any direction while keeping the tubing of a spray nozzle attachment in communication with liquid within the bottle.

A further object of the present invention is to provide a bottle of sprayable liquid with flexible neck that permits a user to flex the neck at any angle and squirt liquid out the nozzle, even when the liquid level is low.

An even further object of the present invention is to provide a bottle of sprayable liquid with flexible neck that permits a user to squirt liquid in an upward direction without having to tilt the body of the bottle.

The present invention fulfills the above and other objects by providing a bottle of sprayable liquid having a flexible neck. The bottle comprises a body, wherein the liquid is contained, and a flexible neck that permits significant flexing to allow users to position a spray nozzle attachment in many positions. The flexible neck has a threaded top end to allow a user to secure conventional spray nozzle attachments thereto.

To use the present invention, a user first pours a liquid into the body of the bottle. Then, he or she inserts the tubing of the spray nozzle attachment into the body of the bottle. The user then secures the attachment ring of the spray nozzle attachment to the threaded top end of the neck. The user may then position the neck at any angle and aim the nozzle at the surface to be sprayed. Because the neck is so flexible, a user can flex the neck such that the spray nozzle attachment is next to the body of the bottle. This is especially useful when a person desires to spray upwards. In addition, because the body of the bottle does not require tilting when spraying the hard-to-reach places, a user can utilize all of the liquid in the bottle without air pockets entering the tubing.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

FIG. 1 is a side cut-away view of the bottle of the present invention with a spray nozzle attached thereon;

FIG. 2 is a side partial cut-away view of the bottle of the present invention; and

FIG. 3 is a side cut-away view of the embodiment of FIG. 1 with a flexible neck positioned away from its vertical axis.

### DESCRIPTION OF THE PREFERRED EMBODIMENTS

For purposes of describing the preferred embodiment, the terminology used in reference to the numbered components in the drawings is as follows:

| | |
|---|---|
| 1. bottle | 7. nozzle |
| 2. neck | 8. groove |
| 3. spray nozzle attachment | 9. lip |
| 4. attachment ring | 10. threading |
| 5. body | 11. tubing |
| 6. trigger | 12. liquid |

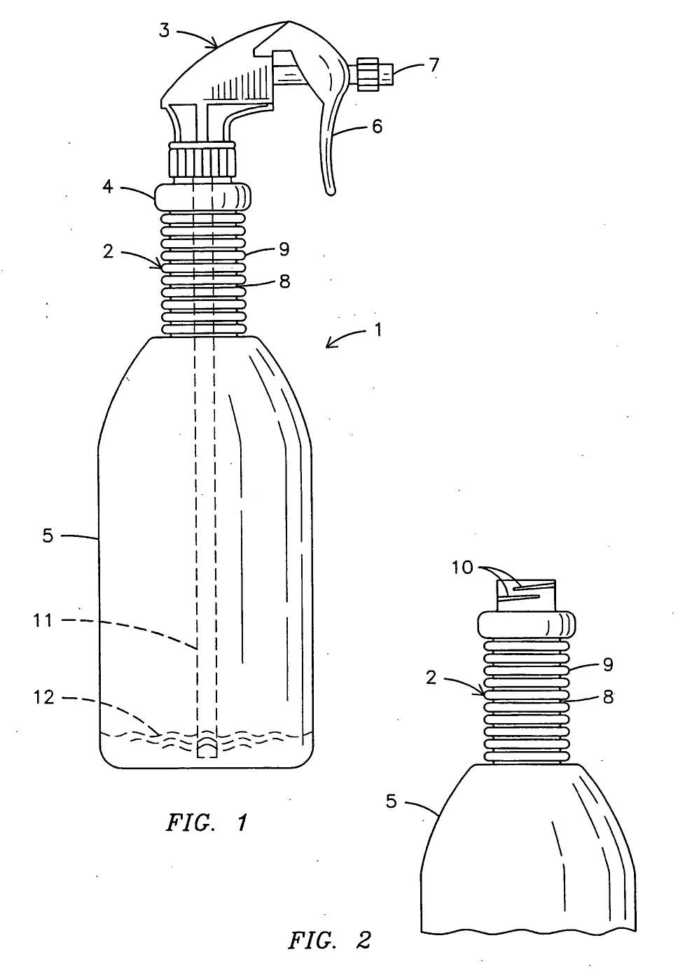

With reference to FIG. 1, a side cut-away view of a bottle of the present invention is shown. The bottle 1 consists of a flexible neck 2 and a body 5 wherein liquid 12 is contained. The flexible neck 2, preferably made of a plastic material, has grooves 8 and lips 9 in order to permit the neck 2 to be flexed in many directions, including a position wherein the spray nozzle attachment 3 is next to the body 5 of the bottle 1. A conventional spray nozzle attachment 3 having an attachment ring 4, a trigger 6, a nozzle 7 and tubing 11 may be used in conjunction with the present invention. To use the present invention, a user simply inserts the tubing 11 of the spray nozzle attachment 3 into the body 5 of the bottle 12 with liquid 12, secures the spray nozzle attachment 3 to the upper part of the neck 2, positions the bottle 1 and neck 2 as desired and pulls the trigger 6 to release the liquid 12 through the nozzle 7. Because the neck 2 is so flexible, the neck 2 can be moved from a centerline of the bottle 1 in any direction over a 360 degree radius and continue to spray liquid 12 from the bottle 1.

In FIG. 2, a side partial cut-away view of the bottle of the present invention is shown. The upper part of the neck 2 has threading 10, which corresponds to the threading on the spray nozzle attachment 3, to allow the spray nozzle attachment 3 to be secured to the bottle 1. The grooves 8 and lips 9 on the neck 2 allow for flexing of the neck 2.

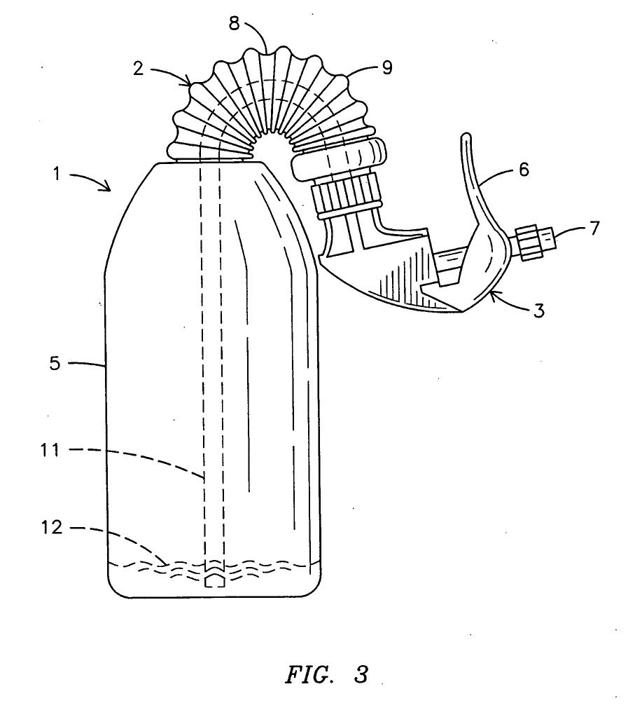

With reference to FIG. 3, a side cut-away view of the embodiment of FIG. 1 with a flexible neck positioned away from its vertical axis is shown. Because the neck 2 is so flexible, a user may position the neck 2 such that it is essentially flexed in half in order to squirt surfaces. This feature is unique in that a user may squirt liquid 12 from the bottle 1 in an upward direction while the tubing 11 is still in contact with the liquid 12, even when the liquid 12 is low.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

1. A bottle comprising:
an elongated flexible neck having grooves and lips:
said flexible neck having a threaded upper end:
a body affixed to said flexible neck: and
a spray nozzle attachment having tubing which permits the flexible neck to be moved from a centerline of the bottle in any direction over a 360 degree radius and continue to spray liquid from the bottle.

2. The bottle of claim 1 wherein the spray nozzle attachment may be attached onto the upper end of the flexible neck.

3. The bottle of claim 1 wherein a sprayable liquid is within said body.

4. The bottle of claim 1 wherein the neck is made of a plastic material.

5. The bottle of claim 3 wherein said liquid is less viscous than conventional automobile engine oil.

6. The bottle of claim 1 wherein the body is made of a plastic material.

7. The bottle of claim 1 wherein:
the spray nozzle attachment has an attachment ring:
said attachment ring is threaded, and
said attachment ring threads correspond with said threaded upper end of said neck.

8. The bottle of claim 1 wherein:
said tubing is sized so as to fit within said body.
